(19) United States
(12) Patent Application Publication
(10) Pub. No.: US 2017/0187419 A1
(43) Pub. Date: Jun. 29, 2017

(54) Shielded bundle interconnect

(71) Applicant: Intel Corporation, Santa Clara, CA (US)

(72) Inventors: Yu Zhang, Chandler, AZ (US); Mathew J. Manusharow, Phoenix, AZ (US); Adel A. Elsherbini, Chandler, AZ (US); Henning Braunisch, Phoenix, AZ (US); Kemal Aygun, Chandler, AZ (US)

(21) Appl. No.: 14/998,254

(22) Filed: Dec. 26, 2015

(51) Int. Cl. H04B 3/32; H04L 5/14

(52) U.S. Cl. CPC H04B 3/32; H04L 5/1446

(57) ABSTRACT

Embodiments are generally directed to a shielded bundle interconnect. An embodiment of an apparatus includes multiple signal bundles, the signal bundles including a first signal bundle including a first plurality of signals and a second signal bundle including a second plurality of signals; and a lithographic via shielding to provide electromagnetic shielding, the lithographic via shielding located at least in part between the first signal bundle and the second signal bundle, wherein the lithographic via shielding includes at least a via generated by a lithographic via process. The lithographic via shielding partially or completely surrounds at least one of the signal bundles of the apparatus.

### TECHNICAL FIELD

Embodiments described herein generally relate to the field of electronic devices and, more particularly, to a shielded bundle interconnect.

### BACKGROUND

High speed signaling continues to be a very significant factor in providing for higher performance computing across the market spectrum. In current operations, server computing is nearing 25 Gbit/s (gigabits per second) per transmission line signaling, client computing is approaching 20 Gbit/s signaling, and mobile computing is approaching 10 Gbit/s. Further, it can be expected signaling at these speeds will shortly seem slow.

A particular limiting factor in high speed signals is crosstalk between signals, which is itself limited by the availability of shielding of signals. As this trend in signaling speeds continues, conventional methods for signal transfer will become incapable of supporting the future data rates, and in particular will be incapable of providing sufficient shielding to allow for the high speeds signaling.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a bundle interconnect that is shielded using a lithographically defined via;

FIG. 2A is an illustration of shielding by a conventional ground webbing structure in a device;

FIG. 2B is an illustration of lithographic via shielding in a pad layer ground webbing structure according to an embodiment;

FIG. 3A is an illustration of shielding by a conventional fence shielding in a via layer of a device;

FIG. 3B is an illustration of lithographic wall shielding of signal bundles at a via layer according to an embodiment;

FIG. 4A is an illustration of shielding by a conventional guard trace structure at a channel layer for a stripline single layer bundle;

FIG. 4B is an illustration of shielding with a lithographic via guard trace structure for a stripline single layer bundle according to an embodiment;

FIG. 5A is an illustration of shielding by a conventional guard trace structure for a two-wire broadside coupling bundle;

FIG. 5B is an illustration of shielding with a lithographic via guard trace structure for a two-wire broadside coupling bundle at a channel layer according to an embodiment;

FIG. 6 is an illustration of an on-package interconnect with multi-chip on package architecture including shielding with a lithographic vie structure according to an embodiment; and

FIG. 7 is a flowchart to illustrate a process for implementation of a shielded bundle interconnect according to an embodiment.

### DETAILED DESCRIPTION

Embodiments described herein are generally directed to a shielded bundle interconnect.

For the purposes of this description:

“Crosstalk” refers in general in an undesired coupling of energy between two channels or circuits, and more specifically refers to a signal that is transmitted on a first channel or circuit creating an undesired effect on another channel or circuit as a result of electromagnetic interference (EMI).

In some embodiments, an apparatus, system, or method provides for a shielded interconnect bundle, wherein the shielding includes, but is not limited to, a lithographically defined via structure, which may be referred to herein as a lithographic via.

As used herein, lithographic via technology includes a process for creating a void of any shape in a material, including a packaging material, and for filling the void with a metal material using lithography to create a via structure. In general, a lithographic via technology replaces laser drilling for via formation with a lithographic process to form a via on, for example, the via pad prior to depositing the next dielectric layer. More specifically, a process for forming a lithographic conductive via includes forming a via pad over a first dielectric layer; depositing a photoresist layer over the first dielectric layer and the via pad; patterning the photoresist layer to form a via opening over the via pad; depositing a conductive material into the via opening to form a via over the via pad; removing the photoresist layer; forming a second dielectric layer over the first dielectric layer, the via pad, and the via, wherein a top surface of the second dielectric layer is formed above a top surface of the via; and recessing the second dielectric layer to expose a top portion of the via.

In some embodiments, a lithographic via provides for a shielding material (metal) that continues through a layer of material, and thus may be utilized to provide a greatly improved electromagnetic shielding for a bundle of signals in comparison with conventional shielding in a material.

In some embodiments, a number of signals (any number of two or more) are gathered into a bundle of signals, with the bundles being shielded from each other, the shielding includes, but is not limited to, shielding through a layer generated by lithographic via technology. As used here, a lithographic via shield refers to a shield structure that includes at least a portion of shielding provided by a lithographic via.

In some embodiments, a lithograph via shield may be optionally combined with active crosstalk cancellation, wherein active crosstalk cancellation refers to any electronic means of reducing crosstalk in circuits or channels. Examples of active crosstalk cancellation may include, but are not limited to, multi-mode signaling on signal channels. In some embodiments, a shielding technology includes bundling of signals into one or more signal bundles, and the provision of lithographic via shielding between the signal bundles. In some embodiments, the shielding technology may further include active cross-talk cancellation for the signals within each bundle of signals.

A particular metric that is increasingly used to couple the concepts of increased performance and the scalability of such performance is “bandwidth density”. Bandwidth density is measured in, for example, bits per second per unit length of die perimeter, wherein 6 Gb/s/mm is an example for a particular die. Thus, a solution that increases signal performance without requiring a significant amount of new area will have a higher bandwidth density than a solution that requires more in order to provide a similar increase in signal performance.

In some embodiments, the bandwidth density metric over current high speed IO methodologies is increased by allowing for higher speed signal transmission using a reduced portion of a die, the reduced portion being enabled by lithographically defined via shielding that provides improved shielding in a smaller area by continuing the shielding material through the dielectric layers of the package, thus allowing for significant reduction of crosstalk.

In some embodiments, shielded bundle technology allows for reduced crosstalk due to the isolation and shielding of the signals, together with optimization in the choice of signals for bundling. Utilizing this technology, a higher speed of signaling can be achieved, and a higher overall bandwidth density can be achieved.

Optional application of active crosstalk cancelation may then be limited to one or more well defined, compact bundles that are shielded by a lithographic via shield, which thus provides reduced I/O circuit complexity. In some embodiments, a shielded bundle interconnect can be paired with any kind of active crosstalk cancelation technology (at the bundle level) to achieve higher crosstalk cancelation efficiency as needed for particular signal bundles.

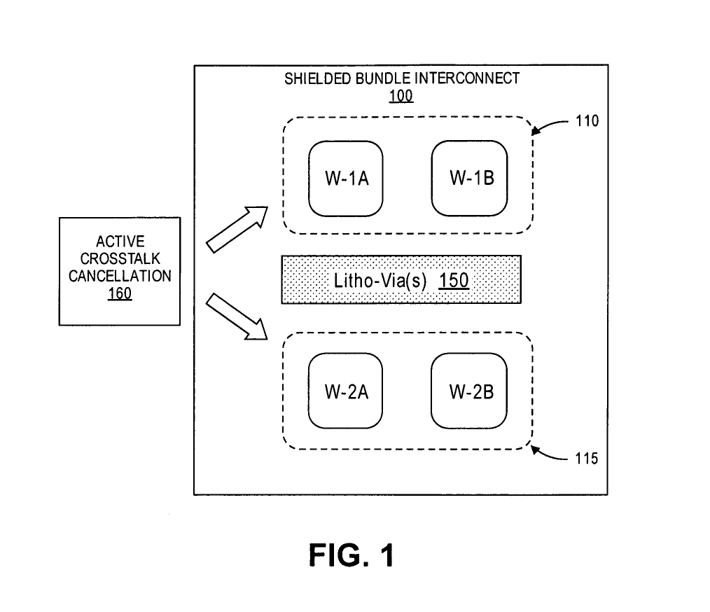

FIG. 1 is an illustration of a bundle interconnect that is shielded using a lithographically defined via. As illustrated in FIG. 1, for bundled shield interconnect, a pair of conductors (W-1A and W-1B) represent a first signal bundle 110 and a second pair of conductors (W-2A and W-2B) represent a second signal bundle 115, wherein the conductors may be formed through a material such as a silicon substrate or a semiconductor package. In other embodiments, different signal bundles may be chosen. The conductors may have different shapes and provide different types of signaling depending on a particular implementation. For the purposes of this illustration it may be assumed that signals transmitted on each of the conductors is presented at a high signaling speed.

Without proper shielding, there likely will be significant cross-talk between the signal bundles. Further, conventional shielding mechanisms, are insufficient to provide sufficient shielding in a high speed/short distance implementation.

In some embodiments, the signal bundles are shielded from each other by a shielding that includes at least a portion that is generated by a lithographic via process. As it is possible to create any shape of via using a lithographic via process, the one or more lithographic vias 150 may be in a form required to provide an effective shielding between (or around) the first signal bundle (W-1A and W-1B) 110 and the second signal bundle (W-2A and W-2B) 115. In some embodiments, the lithographic via shield is at least in part between the first signal bundle and the second signal bundle. In some embodiments, the lithographic via shielding partially or completely surrounds at least one of the signal bundles of the apparatus.

In some embodiments, a shielded bundle technology may further include application of active crosstalk cancellation 160, wherein the active crosstalk cancellation may be limited to application within each signal bundle 110-115, such as cancellation of crosstalk occurring between the signals on W-1A and W-1B, and cancellation of crosstalk occurring between the signals on W-2A and W-2B.

In some embodiments, shielded bundle technology may be implemented on one or more of a pad layer; on a via layer below the pad layer; or on a channel layer providing the channel connection between devices.

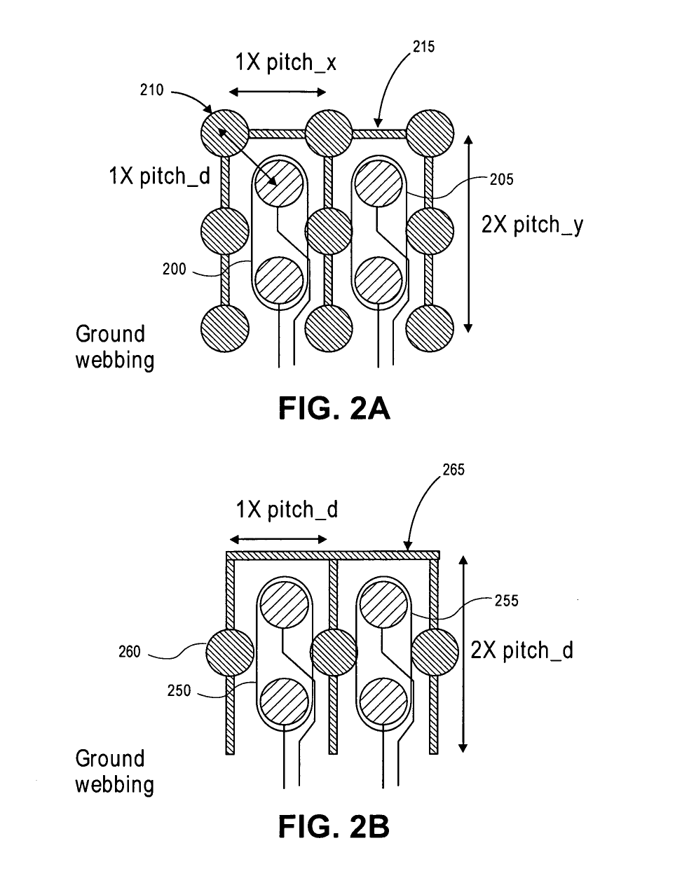

FIG. 2A is an illustration of shielding by a conventional ground webbing structure in a device. Shown in FIG. 2A is a surface or pad level view of bump-out bundling, with FIG. 2A specifically illustrating 2-wire bundles with ground webbing. The conventional design methodology in FIG. 2A utilizes a standard C4 bump level pitch (C4 referring to solder reflow and solder bump technology), wherein the solder bumps are utilized to group signals with grounds. As shown, the bumps shown are the terminations of vias formed in a z-direction, perpendicular to a surface of the material layer. A shielding bundle includes a first bundle of signals 200 and a second bundle of signals 205. Crosstalk under the C4 bump area may be generated by the coupling between signal vias and coupling between signal vias and signal transmission line routing through vias.

As further shown, a set of ground vias terminating at the ground bumps 210 are formed through the material layer and are interconnected by traces 215 to form a ground webbing shield. Also illustrated are the bumps associated with the first signal bundle 200 and the second signal bundle 205, each representing a pair of signal vias in the illustrated examples. However, the signal bundles may include any number of signals. Because of the size of the terminating solder bumps of the ground vias and the solder bumps of the signal vias, there is a certain pitch or distance (pitch_d) between the bumps. Because of this pitch distance, the ground bumps are required to be a certain pitch apart in the x-direction (pitch_x) and y-direction (pitch_y). Thus, the area required for shielding of a signal pair arranged in the y-direction is (1× pitch_x) times (2× pitch_y). In some embodiments, the application of lithographic via technology reduces the required number of ground C4 bumps in comparison with traditional technology, with equal or less crosstalk coupling under the C4 bump field, thereby reducing the silicon IO area, and thus the silicon cost.

In addition, with the ground vias being formed in a z-direction to another layer, there is not enough isolation to provide sufficient shielding of the signal vias. There are large openings between these ground vias, which reduces the effectiveness of their electromagnetic shielding.

FIG. 2B is an illustration of lithographic via shielding in a pad layer ground webbing structure according to an embodiment. In some embodiments, as illustrated in FIG. 2B, a first signal bundle 250 and a second signal bundle 255 are shielded by a lithographic via shield.

In some embodiments, a ground wedding includes lithographically formed walls or sheets of shielding material 265 between ground vias that terminate at the ground bumps 260, the ground webbing to provide enhanced shielding of the first signal bundle 250 and a second signal bundle 255 terminating at the signal bumps. Thus, as illustrated the lines 265 connecting the ground bumps 260 for the ground vias are themselves vias that continue through the layer of material, and that provide the walls or sheets of metal shielding material.

In this manner, the lithographically defined ground webbing illustrated in FIG. 2B provides a complete electromagnetic shielding of the signal bundles on a via layer. For this reason, the ground shielding does not require as many bumps 260 on the illustrated surface, which are reduced from nine ground bumps 210 required for the shielding of each signal pair 200 in the conventional shielding structure illustrated in FIG. 2A to three ground bumps 250 in the enhanced shielding structure illustrated in FIG. 2B. As illustrated in FIG. 2B, the spacing between signal bumps 250 may be reduced to the required pitch between bumps (pitch_d), resulting in a reduction of the area required to shield a signal pair to (1× pitch_d) times (2× pitch_d), while at a same time improving the electromagnetic shielding between the signal bundles.

In some embodiments, the shielding illustrated by FIG. 2A may be further enhanced by optionally including active crosstalk cancellation between the signals of one or more of the signal bundles 250-255.

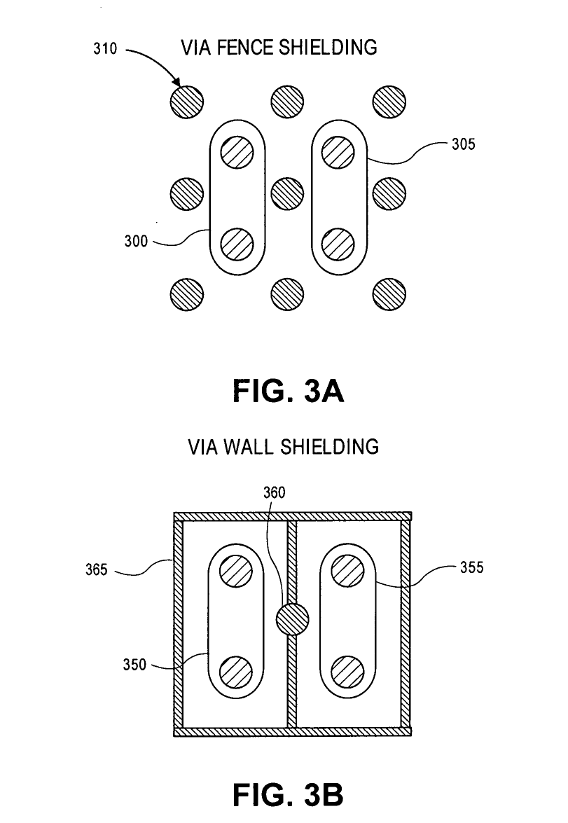

FIG. 3A is an illustration of shielding by a conventional fence shielding in a via layer of a device. Shown in FIG. 3A is a via level view of signal bundling, with FIG. 3A specifically illustrating a 2-wire bundles with fence shielding. FIG. 3A may, for example, illustrate a shielding structure for signals provided by FIG. 2A at a via layer. As shown, each bundle of signal vias, shown as a first signal bundle 300 and a second signal bundle 305 is surrounded by a fence of ground vias 310. However, as clear from the illustration, there is a significant amount of space between ground vias 310, thus limiting the electromagnetic shielding effect of the ground vias and requiring a sufficient distance between signal pairs to avoid cross-talk interference.

FIG. 3B is an illustration of lithographic wall shielding of signal bundles at a via layer according to an embodiment. Shown in FIG. 3B is a via level view of signal bundling, with FIG. 3B illustrating a first 2-wire bundle 350 and a second 2-wire bundle.

In some embodiments, for each signal bundle, a lithographic wall shielding is provided, the lithographic via wall shielding including at least one ground via 365 and a lithographic via wall of metal shielding 360 surrounding the signal pair, the wall of metal shielding being formed by a lithographic via process. In some embodiments, the via wall shielding provides a surrounding shielding wall for the via connections, providing improved electromagnetic shielding in a reduced amount of space for via connections in comparison with conventional shielding.

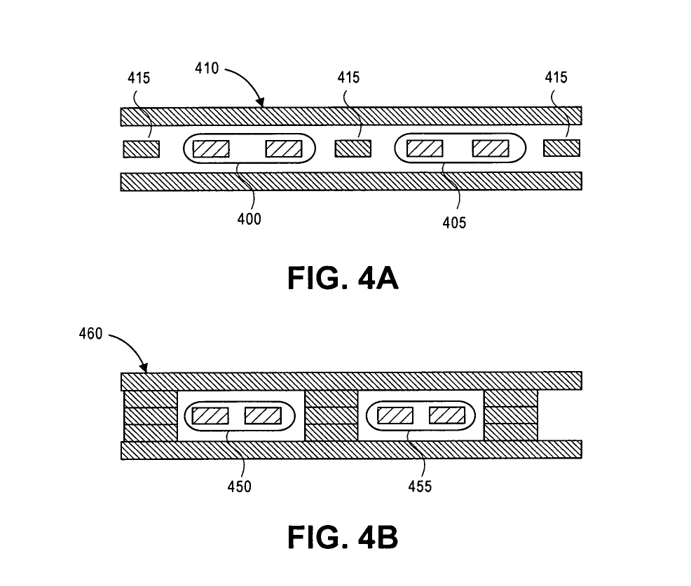

FIG. 4A is an illustration of shielding by a conventional guard trace structure for a stripline single layer bundle. In this particular example, signals are arranged in a single layer, including a first channel signal bundle 400 and a second channel signal bundle 405. In a layer providing interconnection of channels, a conventional shielding structure 410 may include shielding lines 415 between the bundles of channel signals 400 and 405.

However, the conventional shielding of the channels allows gaps between the signal bundles, thus requiring additional spacing between the channels to reduce crosstalk between signal bundles.

FIG. 4B is an illustration of shielding with a lithographic via guard trace structure at a channel layer for a stripline single layer bundle according to an embodiment. In this particular illustration, signals are arranged in a single layer, including a first channel signal bundle 450 and a second channel signal bundle 455.

In some embodiments, in contrast with conventional shielding, a lithographic via channel shield structure 460 is formed to fully surround each of the illustrated channel signal bundles 450 and 455. In this manner, the electromagnetic shielding for each channel signal bundle is improved, and the signal bundles may be arranged closer together, thus reducing the amount of area required for shielded channel signals.

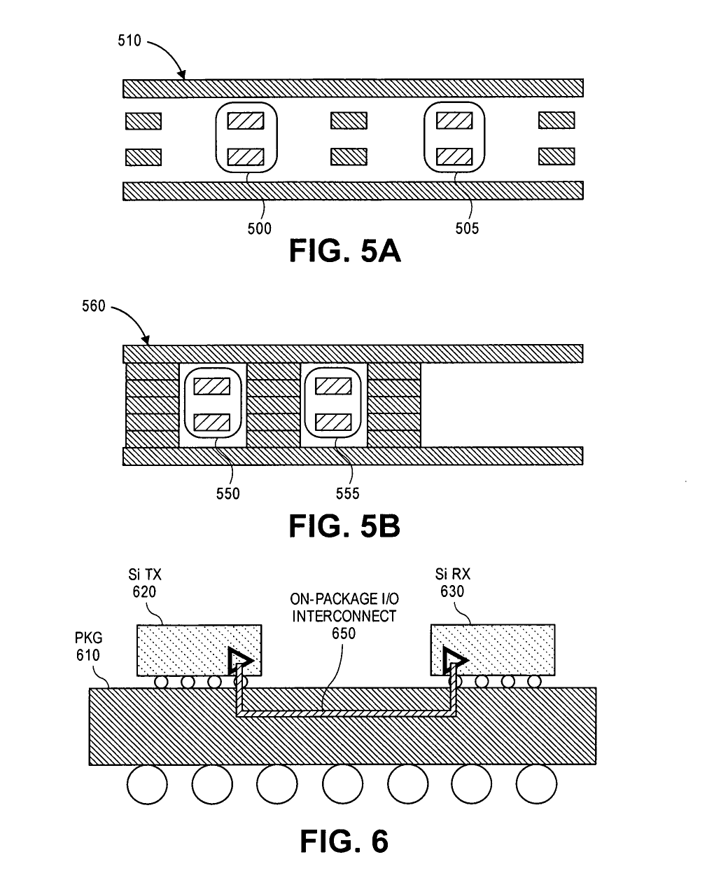

FIG. 5A is an illustration of shielding by a conventional guard trace structure for a two-wire broadside coupling bundle. In this particular illustration, the channels are arranged in a stacked fashion, including a first channel signal bundle 500 and a second channel signal bundle 505. In a layer providing interconnection of channels, a conventional shielding structure 510 may include multiple shielding lines 515 between the bundles of channel signals 500 and 505,

However, the conventional electromagnetic shielding of the channels allows gaps been the signal bundles, including potential direct gaps between certain channels, thus again requiring additional spacing between the channels to reduce crosstalk between signal bundles.

FIG. 5B is an illustration of shielding with a lithographic via guard trace structure for a two-wire broadside coupling bundle at a channel layer according to an embodiment. In this particular illustration, signals are arranged in multiple layers, including a first channel signal bundle 550 and a second channel signal bundle 555.

In some embodiments, in contrast with conventional shielding, a lithographic via channel shield structure 460 is formed to fully surround each of the illustrated channel signal bundles 450 and 455. In this manner, the lithographic via channel shield improves shielding for each channel signal bundle is improved, allow for the signal bundles to be arranged closer together, thus reducing the amount of area required for shielded channel signals.

It is noted that signal bundles may include any number of signals, and thus the lithographic via shielding between the illustrated signal bundles in FIGS. 2B, 3B, 4B, and 5B may be expanded to accommodate any number of signals. Embodiments are not limited to the lithographic shielding structures as illustrated in such figures, but rather may include any shape of lithographic via shielding to separate or surround signal bundles as required for the particular number and type of signals. A structure of the lithographic via shielding is dependent least in part on a number of signals in each signal bundle.

FIG. 6 is an illustration of an on-package interconnect with multi-chip on package architecture including shielding with a lithographic via structure according to an embodiment. On-Package IO (OPIO) is a single-ended high speed signaling interface paired with multiple chips on a package architecture. The OPIO channel operates with high routing density and high data rate to meet rapidly increasing high bandwidth demand. Thus, using conventional shielding structures and processes, the OPIO channel suffers channel crosstalk issues due to dense package routing, and consequently results in significant eye opening degradation in an eye pattern (wherein an eye pattern refers to a common display of repetitively sampled signals, an open eye describing a signal with minimal distortion while distortion of a signal from interference and noise resulting in closure of the eye pattern).

As illustrated, a system includes a package 610 including an on-package I/O interconnect between a first chip, the first chip being a silicon transmitter 620 in this illustration, and a second chip, the second chip being a silicon receiver 630 in this illustration. However, embodiments are not limited to this particular device and interconnect arrangement.

In some embodiments, a shielded bundle interconnect technology implementing lithographic via technology, such as illustrated in FIG. 1, 2B, 3B, 4B, or 5B, is implemented in the OPIO channel, including, but not limited to the following:

(1) In some embodiments, a lithographic via ground webbing shielding, such as illustrated in FIG. 2B, may be applied at a pad level connection between the package 610 and each of the multiple chips 620 and 620.

(2) In some embodiments, a lithographic via wall shielding, such as illustrated in FIG. 3B, may be applied at a via layer connection for the package 610 for signals to and from the multiple chips 620 and 630.

(3) In some embodiments, a lithographic via wall shielding, such as illustrated in FIGS. 4B and 5B, may be applied at a channel layer connection for the package 610 to provide for channel connections through the package 610.

However, embodiments are not limited to these particular shielding structures, and the package 610 may utilize varying lithographic via shielding structures for the signal bundles utilized in signal transmission.

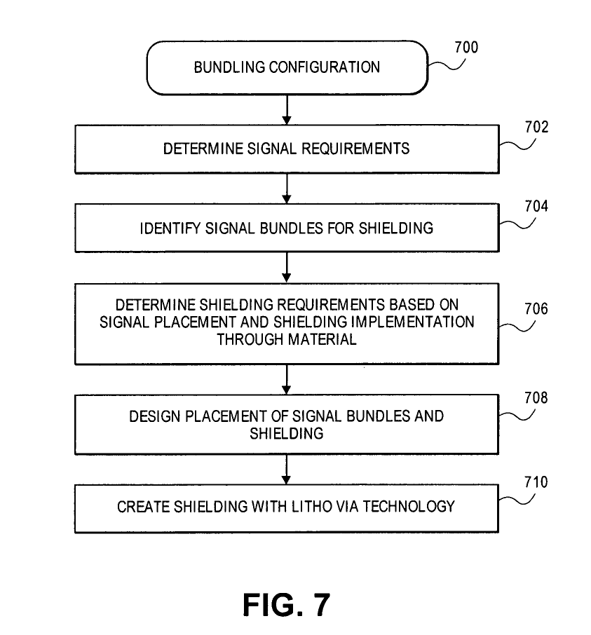

FIG. 7 is a flowchart to illustrate a process for implementation of a shielded bundle interconnect according to an embodiment. In some embodiments, a process for a bundling configuration 700 includes:

702: Determining signal requirements for a particular system, including the signal speeds to implemented on each of a plurality of channels.

704: Identifying signal bundles for shielding, wherein each signal bundle may include any number of two or more signals. In some embodiments, the choice of signal bundles may include separation of signals that may have significant crosstalk issues in operation. While signal bundles will vary in different implementations, signal bundles may commonly include signals of a similar type to avoid signal crosstalk that can greatly degrade signal integrity. For example, a first signal bundle may include data transmission signals; a second signal bundle may include data receptions signals; and a third signal bundle may include clock signals. However, embodiments are not limited to these choices, and may include other types of signal bundles depending on a particular system.

706: Determine shielding requirements for each signal bundle based on the signals within each signal bundle and the potential for crosstalk interference with other signal bundles.

708: Design placement of signal bundles and shielding structure. In some embodiments, the placement may include consideration of the potential inference implications for different types of signals.

710: Create shielding with lithographic via technology. The lithographic shielding structures may include, but are not limited to, shielding structures illustrated in FIGS. 2B, 3B, 4B, and 5B.

712: Optional implementation of active crosstalk cancellation within the signal bundles as required for such signal cancellation.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, an apparatus include a plurality of signal bundles, the plurality of signal bundles including a first signal bundle including a first plurality of signals and a second signal bundle including a second plurality of signals; and a lithographic via shielding to provide electromagnetic shielding for the signal bundles, the lithographic via shielding located at least in part between the first signal bundle and the second signal bundle, wherein the lithographic via shielding includes at least a via generated by a lithographic via process. In some embodiments, the lithographic via shielding partially or completely surrounds at least one of the signal bundles of the apparatus.

In some embodiments, the apparatus further includes logic for active crosstalk cancellation, wherein the active crosstalk cancellation is applied to the signals of the first signal bundle, the signals of the second signal bundle, or both.

In some embodiments, the first signal bundle and the second signal bundle include any number of two or more signals.

In some embodiments, each signal bundle includes signals of a particular type.

In some embodiments, the lithographic via shielding includes a ground webbing connected to one or more ground connections, the lithographic via shielding partially surrounding a signal bundle including a plurality of signal bumps.

In some embodiments, the lithographic via shielding includes a via wall shielding including at least one ground via, the via wall shielding surrounding at least one signal bundle of signal vias.

In some embodiments, the lithographic via shielding includes a channel shielding wall surrounding at least one signal bundle of signal channels.

In some embodiments, the plurality of signal bundles are included in an interface between a first chip and a second chip.

In some embodiments, a method includes fabricating signal connections for a plurality of signal bundles, each signal bundle including a plurality of signals; and fabricating a lithographic via shielding to provide electromagnetic shielding for the signal bundles. In some embodiments, the lithographic via shielding partially or completely surrounds at least one of the signal bundles of the plurality of signal bundles.

In some embodiments, the method further includes applying logic for active crosstalk cancellation, including applying the active crosstalk cancellation to the signals of the first signal bundle, the signal channels of the second signal bundle, or both.

In some embodiments, fabricating the lithographic via shielding includes fabricating a ground webbing connected to one or more ground connections, the lithographic via shielding partially surrounding a signal bundle including a plurality of signal bumps.

In some embodiments, fabricating the lithographic via shielding includes fabricating a via wall shielding including at least one ground via, the via wall shielding surrounding at least one signal bundle of signal vias.

In some embodiments, fabricating the lithographic via shielding includes fabricating a channel shielding wall surrounding at least one signal bundle of signal channels.

In some embodiments, a structure of the lithographic via shielding is dependent on a number of signals in each signal bundle.

In some embodiments, each signal bundle includes signals of a particular type.

In some embodiments, a system includes a package; a plurality of chips coupled with the package, the chips including a first chip and a second chip; an interface within the package, the interface being coupled with the first chip and the second chip, wherein the interface includes a plurality of signal bundles, the plurality of signal bundles including a first signal bundle including a first plurality of signals and a second signal bundle including a second plurality of signals; and a lithographic via shielding to provide electromagnetic shielding for the signal bundles, the lithographic via shielding located at least in part between the first signal bundle and the second signal bundle, wherein the lithographic via shielding includes at least a via generated by a lithographic via process. In some embodiments, the lithographic via shielding partially or completely surrounds at least one of the signal bundles of the system.

In some embodiments, the interface is an on-package IO (OPIO), the interface being a single-ended high speed signaling interface.

In some embodiments, the system further includes logic for active crosstalk cancellation, wherein the active crosstalk cancellation is applied to the signals of the first signal bundle, the signals of the second signal bundle, or both.

In some embodiments, the lithographic via shielding includes a ground webbing connected to one or more ground connections, the lithographic via shielding partially surrounding a signal bundle including a plurality of signal bumps.

In some embodiments, the lithographic via shielding includes a via wall shielding including at least one ground via, the via wall shielding surrounding at least one signal bundle of signal vias.

In some embodiments, the lithographic via shielding includes a channel shielding wall surrounding at least one signal bundle of signal channels.

What is claimed is:

1. An apparatus comprising:
a plurality of signal bundles, the plurality of signal bundles including a first signal bundle including a first plurality of signals and a second signal bundle including a second plurality of signals; and
a lithographic via shielding to provide electromagnetic shielding for the signal bundles, the lithographic via shielding located at least in part between the first signal bundle and the second signal bundle, wherein the lithographic via shielding includes at least a via generated by a lithographic via process;
wherein the lithographic via shielding partially or completely surrounds at least one of the signal bundles of the apparatus.

2. The apparatus of claim 1, further comprising logic for active crosstalk cancellation, wherein the active crosstalk cancellation is applied to the signals of the first signal bundle, the signals of the second signal bundle, or both.

3. The apparatus of claim 1, wherein the first signal bundle and the second signal bundle include any number of two or more signals.

4. The apparatus of claim 3, wherein each signal bundle includes signals of a particular type.

5. The apparatus of claim 1, wherein the lithographic via shielding includes a ground webbing connected to one or more ground connections, the lithographic via shielding partially surrounding a signal bundle including a plurality of signal bumps.

6. The apparatus of claim 1, wherein the lithographic via shielding includes a via wall shielding including at least one ground via, the via wall shielding surrounding at least one signal bundle of signal vias.

7. The apparatus of claim 1, wherein the lithographic via shielding includes a channel shielding wall surrounding at least one signal bundle of signal channels.

8. A method comprising:
fabricating signal connections for a plurality of signal bundles, each signal bundle including a plurality of signals; and
fabricating a lithographic via shielding to provide electromagnetic shielding for the signal bundles;
wherein the lithographic via shielding partially or completely surrounds at least one of the signal bundles of the plurality of signal bundles.

9. The method of claim 8, further comprising:
applying logic for active crosstalk cancellation, including applying the active crosstalk cancellation to the signals of the first signal bundle, the signal channels of the second signal bundle, or both.

10. The method of claim 8, wherein fabricating the lithographic via shielding includes fabricating a ground webbing connected to one or more ground connections, the lithographic via shielding partially surrounding a signal bundle including a plurality of signal bumps.

11. The method of claim 8, wherein fabricating the lithographic via shielding includes fabricating a via wall shielding including at least one ground via, the via wall shielding surrounding at least one signal bundle of signal vias.

12. The method of claim 8, wherein fabricating the lithographic via shielding includes fabricating a channel shielding wall surrounding at least one signal bundle of signal channels.

13. The method of claim 8, wherein a structure of the lithographic via shielding is dependent on a number of signals in each signal bundle.

14. The method of claim 8, wherein each signal bundle includes signals of a particular type.

15. A system comprising:
a package;
a plurality of chips coupled with the package, the chips including a first chip and a second chip;
an interface within the package, the interface being coupled with the first chip and the second chip, wherein the interface includes a plurality of signal bundles, the plurality of signal bundles including a first signal bundle including a first plurality of signals and a second signal bundle including a second plurality of signals; and
a lithographic via shielding to provide electromagnetic shielding for the signal bundles, the lithographic via shielding located at least in part between the first signal bundle and the second signal bundle, wherein the lithographic via shielding includes at least a via generated by a lithographic via process;
wherein the lithographic via shielding partially or completely surrounds at least one of the signal bundles of the system.

16. The system of claim 15, wherein the interface is an on-package IO (OPIO), the interface being a single-ended high speed signaling interface.

17. The system of claim 15, further comprising logic for active crosstalk cancellation, wherein the active crosstalk cancellation is applied to the signals of the first signal bundle, the signals of the second signal bundle, or both.

18. The system of claim 15, wherein the lithographic via shielding includes a ground webbing connected to one or more ground connections, the lithographic via shielding partially surrounding a signal bundle including a plurality of signal bumps.

19. The system of claim 15, wherein the lithographic via shielding includes a via wall shielding including at least one ground via, the via wall shielding surrounding at least one signal bundle of signal vias.

20. The system of claim 15, wherein the lithographic via shielding includes a channel shielding wall surrounding at least one signal bundle of signal channels.
